(19) United States
(12) Patent Application Publication
(10) Pub. No.: US 2025/0235029 A1
(43) Pub. Date: Jul. 24, 2025

(54) SYSTEM AND METHOD FOR VACUUM EXTRACTION OF BREWED BEVERAGES

(71) Applicant: BKON LLC, Newark, DE (US)

(72) Inventors: Dean J. Vastardis, Moorestown, NJ (US); Lou Vastardis, Moorestown, NJ (US); Andrew Rosenbach, Philadelphia, PA (US)

(21) Appl. No.: 19/175,468

(22) Filed: Apr. 10, 2025

Related U.S. Application Data
(63) Continuation of application No. 16/342,259, filed on Apr. 16, 2019, now abandoned.
(60) Provisional application No. 62/409,268, filed on Oct. 17, 2016.

(51) Int. Cl. A47J 31/043; A47J 31/32; A47J 31/44

(52) U.S. Cl. CPC A47J 31/043; A47J 31/44; A47J 31/32

(57) ABSTRACT

A method and system for vacuum extraction of brewed beverages is described. The process includes the steps of preparing a liquid water or solvent to a desired temperature, combining the liquid water or solvent with a first brewing material in a brewing vessel, removing air from the brewing vessel until a first desired pressure set point is reached, steeping the mixture of the liquid water or solvent and the first brewing material in the brewing vessel for a desired low-pressure steeping time, adding a filler gas to the brewing vessel until a second desired pressure set point is reached, steeping the mixture of the liquid water or solvent and the first brewing material in the brewing vessel for a desired steeping time at atmospheric or high-pressure and directing the liquid water or solvent and the first brewing material through a filtration system to yield a filtered brewed beverage. A system capable of performing these steps is also described.

### CROSS-REFERENCE TO RELATED APPLICATIONS

This application is a continuation of U.S. patent application Ser. No. 16/342,259, filed Apr. 16, 2019, which is a national stage filing of PCT international application No. PCT/US2017/056877 filed on Oct. 17, 2017, which claims priority U.S. provisional application No. 62/409,268 filed on Oct. 17, 2016, all of which are incorporated herein by reference in their entireties.

### BACKGROUND OF THE INVENTION

Cold brew coffee, the process of brewing coffee with room-temperature or cold water, is an idea that has been around for at least four centuries, but has very recently seen an exponential increase in demand. Consumers of cold brew are drawn by the lower acidity and more appealing flavor, but the advantages are counter-balanced by much shorter shelf-life and much longer brewing time. Cold brew coffee is not to be confused with iced coffee, which generally refers to coffee that is brewed hot and then chilled by pouring over or adding ice.

There are currently several products available to make cold brew coffee in small or industrial quantities. Some examples are FILTRON, TODDY, and Japanese slow-drip, all of which require that the coffee and water are exposed to the ambient air during the brewing process. Because the constituent parts of coffee grounds are more soluble at higher temperatures, the cold brewing process requires steeping of four to thirty hours, or sometimes even longer. The largest deficiency of the currently-used cold brew processes is that they cannot properly extract the character, identity or terroir of the coffee beans. Therefore the end product is nondescript and it is often impossible to differentiate one cold brewed coffee from another. The three primary reasons for this inefficiency are brewing temperature, contamination and oxidation.

Brewing with these methods creates oxidation and opportunities for microbial development, thus decreasing the shelf life of the product before it begins to sour and/or degrade. This exposure to environmental elements occurs due to the physics of extraction. In order for the liquid to penetrate inside the structure of the coffee, the liquid must displace the captured CO₂ in the coffee before extraction and hydrolysis can occur. Therefore, by the time the extraction is complete, the CO₂ that once partially protected the coffee from oxidation has now dissipated and has been replaced with ambient air which includes oxygen, bacteria, microbes and yeasts. The exposure of the coffee and water to these elements contaminates the beverage, oxidizes the organic materials and causes volatile flavor compounds to dissipate and/or deteriorate. The longer the product is exposed to these elements, the more it becomes contaminated.

Flavor extraction from coffee and other botanicals with room temperature water is difficult. Specific flavor compounds are released through temperature of the solvent, which acts as a catalyst to release and/or develop acids and volatiles. All existing cold brew coffee methods use room temperature water during the process. This temperature is responsible for creating the “smooth” and “low acid” nature of this beverage. Water temperature has three primary effects: acidity, bitterness and flavor compounds.

One method commonly used in cold brewing to increase flavor development is to use hot water for the first wetting of the coffee (also called the bloom), followed by using room-temperature water for the remainder of the process to minimize bitterness. This short heating stage releases flavor volatiles, but only for a limited time after brewing is complete. The flavors deteriorate as the volatiles have a very short effective life. If the hot water is applied for more than a few seconds, the resulting product will have higher acidity and the grounds will release more bittering compounds, just the same as when brewing a hot cup of coffee. This changes the character of the beverage from smooth and low acid to the same as that of hot brewed or iced coffee if served cold. Such a beverage will no longer fit in the definition of cold brew coffee. Also, if the temperature of the water is too high, extraction occurs and oxidation is expedited.

Cold brew coffee is sometimes produced as a concentrate. The water-to-coffee ratio is typically around 14 mL/g for hot brew coffee versus approximately 5 mL/g for cold brew. Due to the decreased extraction effectiveness of cold water, more coffee must be used to create a beverage with acceptable flavor concentration. Depending on the type of coffee and water quality, final concentration of the beverage can vary. However, typically when the brewing is complete the final product results in a concentrate-to-water dilution ratio of 1:1 while retaining 25-30% of the liquid. Therefore, even if the concentrate is reconstituted at a rate of 1:1, the ratio of coffee to water is typically around 7.5 mL/g, because 30% of the liquid is lost prior to the reconstitution. In this way, the yield from the process is extremely low.

The inefficiency of the cold brew process also limits the density of any concentrated extract. Cold brew coffee requires more grounds per unit of water to brew, so any brewing vessel necessarily produces less cold brew coffee than hot brew coffee. Therefore, there is a natural limit to the density or concentration of the final product.

Thus, there is a need for a cold brew process that is faster and cleaner than those currently known in the art, and one that is capable of producing a concentrate with a higher dilution ratio. The present invention addresses this need.

### SUMMARY OF THE INVENTION

The present invention relates to methods and systems of vacuum-extraction for brewing beverages. In one embodiment, the present invention relates to a vacuum-extraction method, comprising preparing a liquid water or solvent to a desired temperature; combining the liquid water or solvent with a first brewing material in a brewing vessel; removing air from the brewing vessel until a first desired pressure set point is reached; steeping the mixture of the liquid water or solvent and the first brewing material in the brewing vessel for a desired low-pressure steeping time; adding a filler gas to the brewing vessel until a second desired pressure set point is reached; steeping the mixture of the liquid water or solvent and the first brewing material in the brewing vessel for a desired steeping time at atmospheric or high-pressure; and directing the liquid water or solvent and the first brewing material through a filtration system to yield a filtered brewed beverage.

In one embodiment, the first brewing material comprises coffee. In another embodiment, the first brewing material comprises tea. In some embodiments, the filler gas is atmospheric air. In other embodiments, the filler gas comprises an inert gas.

In some embodiments, the methods comprise additional steps. In some embodiments, the method includes the steps of directing the filtered brewed beverage into a holding vessel; adding a second brewing material to the brewing vessel; directing the filtered brewed beverage into the brewing vessel; removing air from the brewing vessel until the first desired pressure set point is reached; steeping the mixture of the filtered brewed beverage and the second brewing material in the brewing vessel for the desired low-pressure steeping time; adding the filler gas to the brewing vessel until the second desired pressure set point is reached; steeping the mixture of the filtered brewed beverage and the second brewing material in the brewing vessel for a desired steeping time at atmospheric or high-pressure; and directing the filtered brewed beverage and the second brewing material through a filtration system to yield a twice-filtered brewed beverage.

The present invention also relates to a system capable of vacuum-extraction brewing, the system comprising a brewing vessel, a gas valve connected on a first port to the brewing vessel, a vacuum pump connected on a first end to the pressure tank, a filtration system, and a holding tank; wherein an output port of the brewing vessel is connected to an input port of the filtration system; wherein an output port of the filtration system is connected to an input port of the holding tank; wherein the vacuum pump removes gas from the brewing vessel in order to reach or maintain a pressure set point; and wherein the gas valve opens to expose the brewing vessel to a filler gas source.

In some embodiments, the system also comprises a circulation vessel wherein an input port of the circulation vessel is connected using a first valve or pump to a second output port of the brewing vessel and wherein an output port of the circulation vessel is connected using a second valve or pump to a second input port of the brewing vessel.

In some embodiments, the system further comprises a brite tank. In some embodiments the system further comprises a packaging step. In some embodiments the system further comprises a water or solvent tank.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of a single-pass production line according to one embodiment;

FIG. 2 is a diagram of a two-pass production line according to one embodiment;

FIG. 3 is a diagram of a multi-pass production line according to one embodiment;

FIG. 4 is a diagram of the flow for an RTD brew path according to one embodiment;

FIG. 5 is a diagram of a recirculation brew path according to one embodiment; and

FIG. 6 is a diagram of an alternate embodiment of a recirculation brew path.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical beverage brewing systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

As used herein, “low-pressure” may mean any pressure that is below atmosphere, such as a vacuum or partial vacuum.

As used herein, “high-pressure” may mean any pressure that is greater than open or atmosphere.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present invention is designed to overcome the deficiencies of the prior art as described above. One aspect of the present invention is to provide a beverage brewing system which creates cold brewed coffee using the most optimal means of production. The improved production method of the present invention yields an extracted concentrate that has significantly higher density than current methods of cold brew coffee production, while also brewing up to 100× faster, minimizing potential contamination, and generating a final product that is more shelf stable than what is known in the art. The present invention accomplishes this without making the beverage more acidic than currently-used methods of cold brewing. The present invention may incorporate any of several vacuum-brewing beverage machines known in the art, for example the device described in Vastardis et al., U.S. Pat. No. 9,295,358, the contents of which is incorporated by reference in its entirety.

In one embodiment of the present invention, the right amount of coffee or other botanicals are added to a first chamber. All or a portion of the water is added to the liquid in the first chamber and a vacuum is created in the first chamber. The vacuum is created using a vacuum pump, which removes air from the first chamber until a set pressure is reached. The set pressure may be measured by a pressure sensor disposed within the first chamber, or by other means. When the set pressure is attained, the system will start a vacuum brewing timer that will run for a set period of time and maintain the vacuum at the set pressure. Once the vacuum brewing time has expired, the chamber will return to atmospheric pressure and the system will start an ambient pressure steeping timer. Once the ambient pressure steeping timer has completed, a vacuum is then re-applied using the vacuum pump, and the steps repeat themselves one or more times until gases are no longer being drawn from the coffee or botanicals and the coffee material is completely saturated with the water or solvent.

After the brewing cycles have completed, the liquid is separated from the extracted coffee or other organic materials using one or more filters. This liquid is then used as the starting liquid and or solvent for the next brew cycle. Therefore, with each recirculation of the materials, the liquid gains more density and dissolves additional organic materials making the liquid more and more concentrated with flavors and/or compounds.

Reference is now made to the drawings. Although the figures show a series of large tanks, the drawings are not meant as a limitation on the scale of possible embodiments of this invention. Unless explicitly stated, the vessels used in each stage of this process may be of any size, shape, or structure possible for the brewing of coffee as known by those skilled in the art. The vessels and the tubing or conduits connecting them may be composed of any material or materials known in the art.

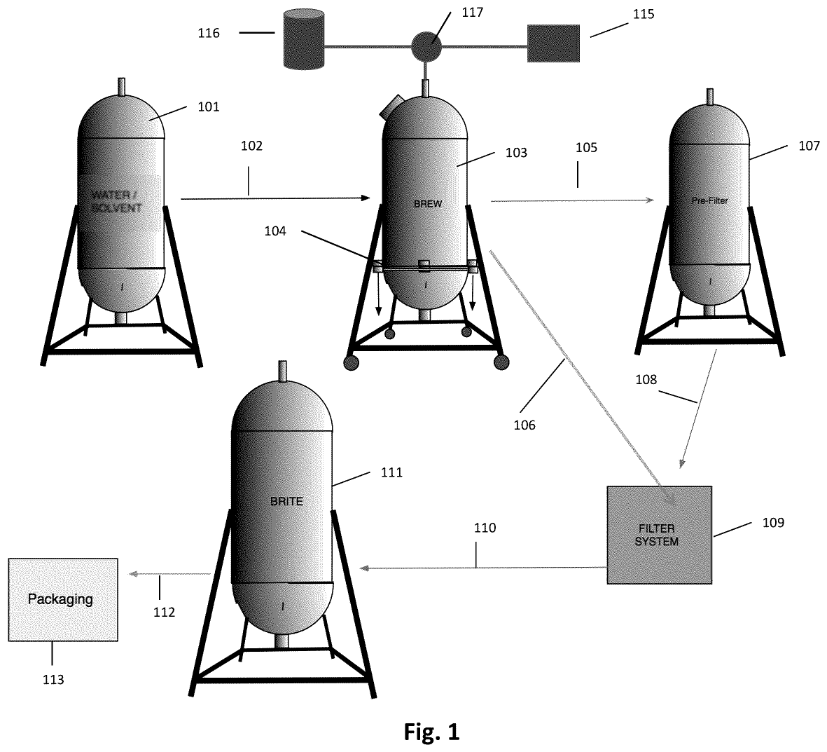

With reference now to FIG. 1, an exemplary embodiment of a single-pass cold brewing process is shown. In the water tank 101, water or another solvent is prepared to the desired temperature and transported through tubing 102 to the vacuum chamber 103. In the vacuum chamber 103, the water is mixed with the brewing materials, which may include coffee and or other materials. In some embodiments, the brewing materials are placed into the vacuum tank 103 before the water is added. In other embodiments, the brewing materials are added to the vacuum tank after the water is added. All or a portion of the water may be added to the vacuum chamber 103 before, during, or after the creation of the vacuum. The vacuum chamber 103 includes a filtration system 104. The vacuum pump 115 will run until the set pressure in the vacuum chamber 103 has been reached. At such time the system will trigger a timer that will run for a set period of time and maintain the set pressure in the vacuum chamber 103. The timer may be triggered by a programmable logic controller (PLC) but other control systems may also be used as is understood by those skilled in the art. Once the vacuum time has expired, a valve 117 opens, allowing for the vacuum chamber 103 to return to approximately normal ambient pressure. The valve may open the chamber 103 to ambient air to equalize the pressure in the chamber, or alternatively may open the chamber to a separate tank full of an inert gas 116. After pressure has been equalized, the system starts a steeping timer, during which the mixture in the chamber 103 will steep at a normal pressure. After the steeping time is complete, a vacuum is applied again to vacuum chamber 103 and the steps repeat themselves one or more times until gases are no longer drawn from the coffee or botanicals and the material is completely saturated into the water or other solvent. When the brewing cycles have completed, the liquid is separated from the extracted coffee or other organic materials though filter 104 and is directed towards a further means of filtration, which will remove finer particles. This may involve a path 105 to the pre-filter tank 107 which stages the liquid while it is being filtered, or a path 106, which allows the filter system to pump the liquid directly from the vacuum chamber 103. Once filtered, the liquid may pass to a brite tank 111 where it may be temperature controlled, scrubbed and infused with nitrogen or another inert gas in order to remove dissolved oxygen from the liquid in order to maximize life of the product. In a final stage, the product is removed from the brite tank via tubing or piping 112 for packaging 113.

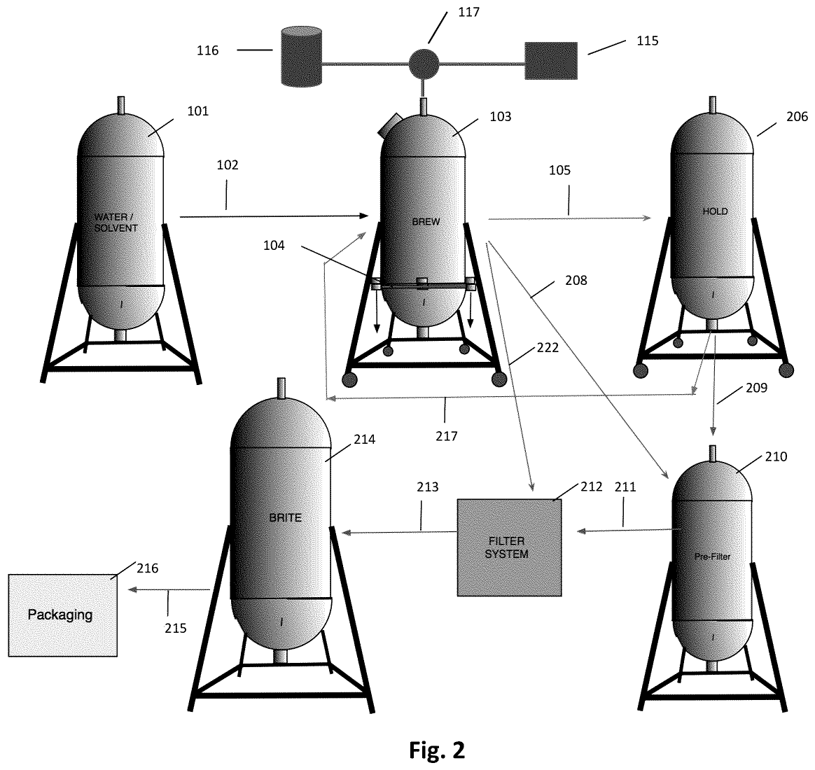

With reference now to FIG. 2, the diagram shows an embodiment of the present invention in which the first pass brewed liquid is recirculated through the system and used as the solvent for subsequent infusion cycles. After multiple passes through the production line, the final product is denser and has better absorbed the flavors and/or organic and inorganic materials as desired. In the water tank 101, water is prepared to the desired temperature, transported though tubing 102 and introduced into the vacuum chamber 103 where the brewing materials (coffee and/or other material) have already been placed above surface of the filtration 104. All or a portion of the water may added to the chamber 103 before, during or after a vacuum is created in the chamber 103. This vacuum pump 115 will run until the set pressure value is reached. At such time the system PLC will trigger a timer that will run for a set period of time and maintain the vacuum at the set pressure. Once the vacuum time has expired, the valve 117 may open in order to return the chamber to approximately normal atmospheric pressure with ambient air or an inert gas 116, then a steeping time will occur. Once the steeping time has completed, a vacuum is then applied and the steps repeat themselves one or more times until the gases are no longer being drawn from the coffee or botanicals and the material is completely saturated into the water (or solvent). When the brewing cycles have completed, the liquid is separated from the extracted coffee and or other organic materials though filter 104 and is directed towards a holding tank 206 where the product may be temperature stabilized to meet the desired temperature similar to the water or solvent that was initially used for the first pass brew cycle. Once the brew chamber 103 is prepared with new materials for extraction, the product will pass through a path 217 back to the brew chamber and be will be introduced as the new solvent for a next brew cycle. Additional water or solvent held at a similar temperature may be introduced into the chamber in order to make up for liquid which had been lost or absorbed by brewing materials in the previous brew cycle pass, and/or liquid which remains in the tubes, pumps or valves. In other embodiments, no water is added so that less liquid is recirculated. The hold tank may contain product from at least one earlier pass brew cycle, allowing the complete volume of liquid to be reintroduced into the chamber 103 without need to dilute with water or clean solvent. This recirculation may occur once or multiple times depending on the application for the final product. Once the final brew cycle pass is complete, in some embodiments, the product will follow a path 208 to a pre-filter tank 210 which stages the liquid, which is being filtered. In other embodiments, the product will follow a path 222 which allows the filter system to pump the liquid directly from the vacuum chamber 103. Once filtered the liquid may pass to a brite tank 214 where it may be stored at a desired temperature, scrubbed and infused with nitrogen or another inert gas in order to remove dissolved oxygen from the liquid and maximize the life of the product. It is assumed that movement of the liquid product through the system may be achieved through known means of pumping or displacement with liquid or gas.

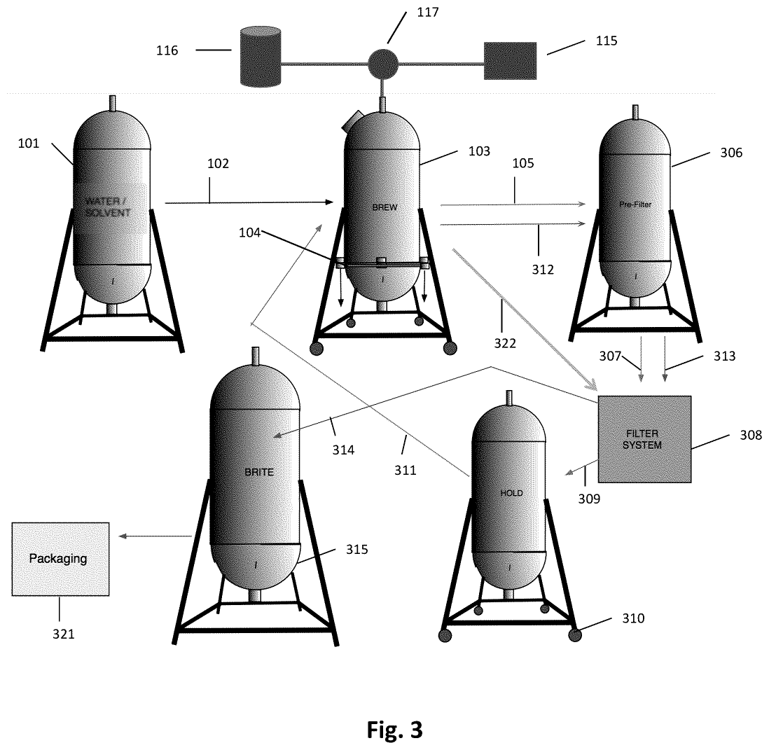

With reference now to FIG. 3, the diagram depicts a brewing application where the first pass brewed liquid is recirculated through the system and used as the solvent for multiple infusion cycles. The liquid passes through a production line and is fine filtered between passes in order to make the final product as dense with flavors and or organic and inorganic materials as desired. In the water tank 101, water is prepared to the desired temperature, transported though tubing 102 introduced into the vacuum chamber 103 where the brewing materials (coffee or other material) have already been placed above surface of the filtration 104. All or a portion of the water may be added to the chamber 103 before, during or after a vacuum is created in the chamber 103. The vacuum pump 115 will run until the set pressure value is reached. At such time the system PLC will trigger a timer that will run for a set period of time and maintain the vacuum at the set pressure value. Once the vacuum time has expired the valve 117 may open in order for the chamber 103 to return to approximately normal atmospheric pressure with ambient air or an inert gas 116, then a steeping time will occur. Once the steeping time has completed, a vacuum is then applied and the steps repeat themselves one or more times until there are no longer gasses being drawn from the coffee or botanicals and the material is completely saturated into the water or solvent. When the brewing cycles have completed, the liquid is separated from the extracted coffee and or other organic materials through the filter 104 and the liquid is directed towards a pre-filter tank 306 which stages the liquid being filtered, or a path 322 which allows the filter system 308 to pump the liquid directly from the vacuum chamber 103. After fine filtration is completed the liquid is passed through to a hold tank where the product may be temperature stabilized to meet a desired temperature similar to the water or solvent that was initially used for the first pass brew cycle. Once the vacuum chamber 103 is prepared with new materials for extraction, the product will pass through a path 311 back to the vacuum chamber 103 and be introduced as the new solvent for a next brew cycle. Water or solvent held at a similar temperature may be introduced into the chamber as well in order to make up for liquid which had been lost in the system. Alternately, no water is added so that less liquid is recirculated. The hold tank may contain product from one or more earlier passes of the brew cycle, allowing the complete volume of liquid to be reintroduced into the chamber 103 without needing to dilute with water or clean solvent. This recirculation may occur one or multiple times depending on the application for the final product. Once the final brew cycle pass is complete, the product with follow a path 312 to a pre-filter tank 306 which stages the liquid for final filtration, or a path 322 which allows the filter system to pump the liquid directly from the vacuum chamber 103. Once filtered, the liquid passes to a brite tank 315 where it may be temperature-maintained, scrubbed and infused with nitrogen or another inert gas in order to remove dissolved oxygen from the liquid in order to maximize life of the product. It is assumed that movement of the liquid product through the system may be achieved with existing means of pumping or displacement with liquid or gas.

FIGS. 1-3 show a system capable of creating a more shelf stable beverage. Whereas current cold brew methods steep for longer periods of time, this method is greatly expedited by the efficiency of the extraction process. By controlling the vacuum parameters, time, and temperature of the infusion cycle, the user can better control the pH level of the final product. Since pH affects microbial growth, the stability of this product can be controlled though the use of the method as described above. In addition, inert gasses can be used during the brewing process to further increase shelf life

FIGS. 2-3 show a system which is capable of producing a more flavorful beverage or concentrate. By recirculating the finished product through the system and using this liquid as the solvent for the subsequent infusion cycle, the process substantially increases the total dissolved solids each time the product is recirculated and infused further. Existing processes to create concentrates typically use evaporation of an existing fully brewed beverage in order to get the concentration of the present invention. Known evaporative methods are less effective because the heating changes the compounds in the solution and therefore does not accurately convey the character of the product. This invention can create the optimal flavor extractions from each material to increase the Total Dissolved Solids (TDS) exponentially each time the infusion occurs by adding new brewing matter. Therefore, the system of the present invention adds to the liquid rather than removing liquid to increase concentration. The method of the present invention can create a concentration of solids which can only be found in espresso for a ready to drink beverage with a single cycle of the recirculation, or can create extracts that have a dilution ratio sufficient for industrial bottling with ratios of 4:1 or greater. This method may also be applied to botanicals to extract organic and inorganic compounds for use in pharmaceutical applications.

An example of this this process is the creation of cold brew espresso. Espresso is considered the highest form of specialty coffee, and is the most popular way coffee is consumed globally. However, espresso lacks an ability to tap into massive consumer demand for cold refreshment or on-the-go energy. Due to the heat and positive pressure utilized by the traditional extraction process, espresso needs to be consumed immediately after the shot is pulled and cannot be stabilized for ready-to-drink applications. Through applying the method shown in FIGS. 2-3, the present invention can create espresso with more of the flavors, sugars, and other compounds from the coffee, which in the existing art are only available in hot espresso. The present invention produces this beverage with lower acidity, and in a way that can be served cold or packaged for later consumption.

Brewing temperatures for these described methods have been shown to be optimal in the range of 85-205 F. Although it has been noted that the most flavorful and balanced coffee products have been produced above room temperature at a range of approximately 115 F., and botanicals at approximately 165 F., the temperature range may be dependent on the coffee and/or botanicals. Although the temperature plays a role in the flavor development, it is the combination of the right temperature for the right material plus the controlled vacuums with the slope and hold time which create the stable product. The pH can fluctuate in food over the course of its shelf life as the result of precipitating out or enzymatic activity. As a result of the brew process as compared to a control of standard methods, the product produced by the method of the present invention creates a pH with fewer fluctuations over time. Given the circumstances, the pH stability is likely the result of prohibition of enzymatic activity in the present invention.

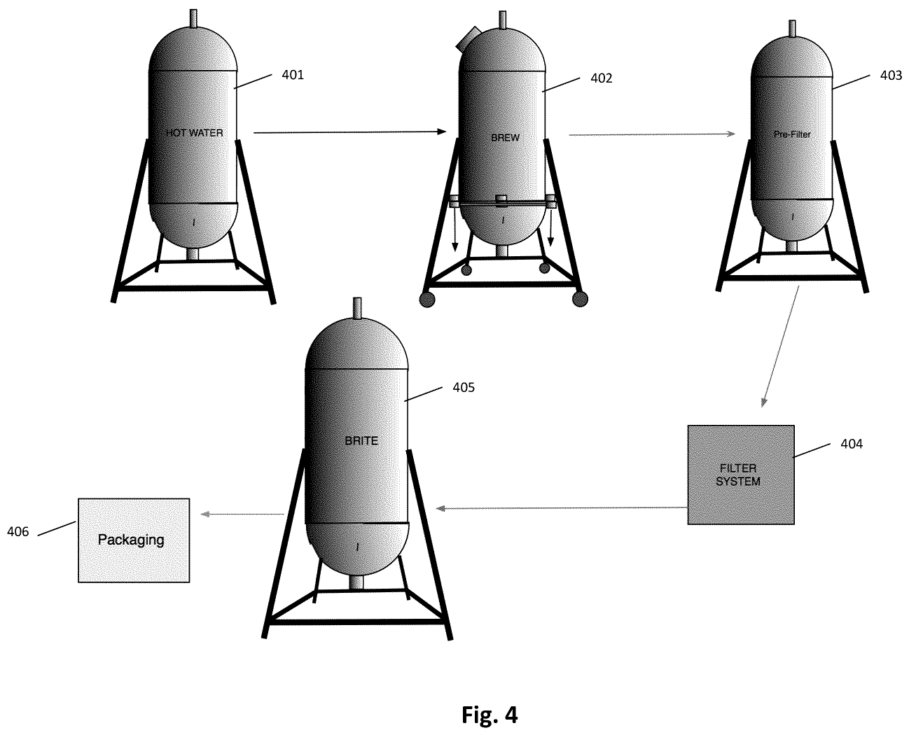

FIGS. 4-6 are detailed views of individual flow cycles from FIGS. 1-3. FIG. 4 shows a simple, single cycle brew beginning at a first water vessel 401, continuing to a vacuum/brewing vessel 402, a pre-filter vessel 403, a filtration system 404, and finally a brite tank 405 before proceeding to packaging 406.

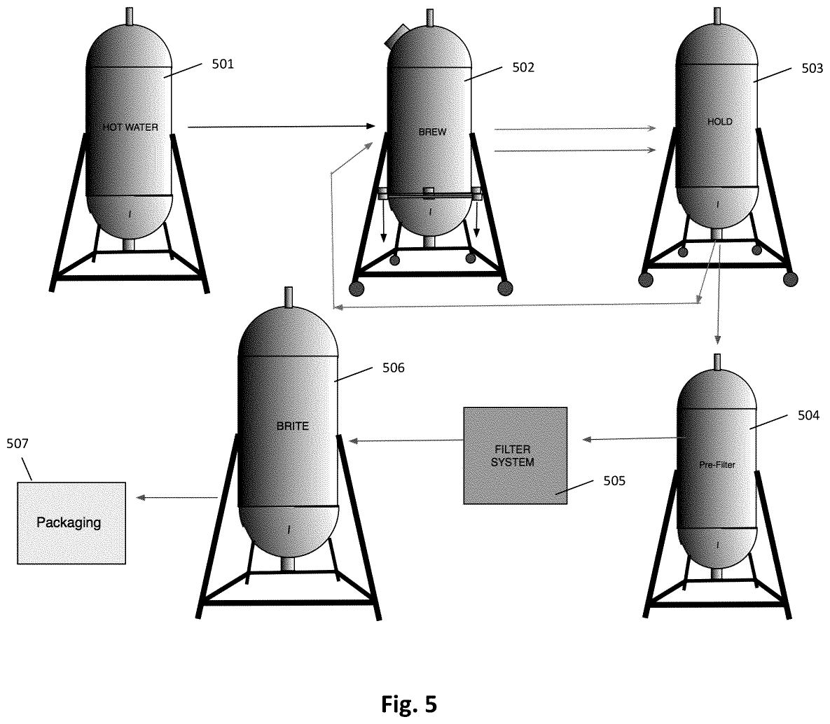

FIG. 5 shows a single recirculation loop from the brewing system of FIG. 2. Water or a solvent beings at a first water vessel 501, proceeds to a vacuum/brewing vessel 502, a holding vessel 503, then back to the vacuum/brewing vessel 502 after new coffee or materials have been added for a second brewing and steeping cycle. After the second cycle is complete, the liquid may proceed either back to the vacuum/brewing vessel 502 for a further brewing and steeping cycle or to a pre-filter vessel 504 to go through a filtration system 505. The filtered liquid then proceeds to the brite tank 506 before packaging 507.

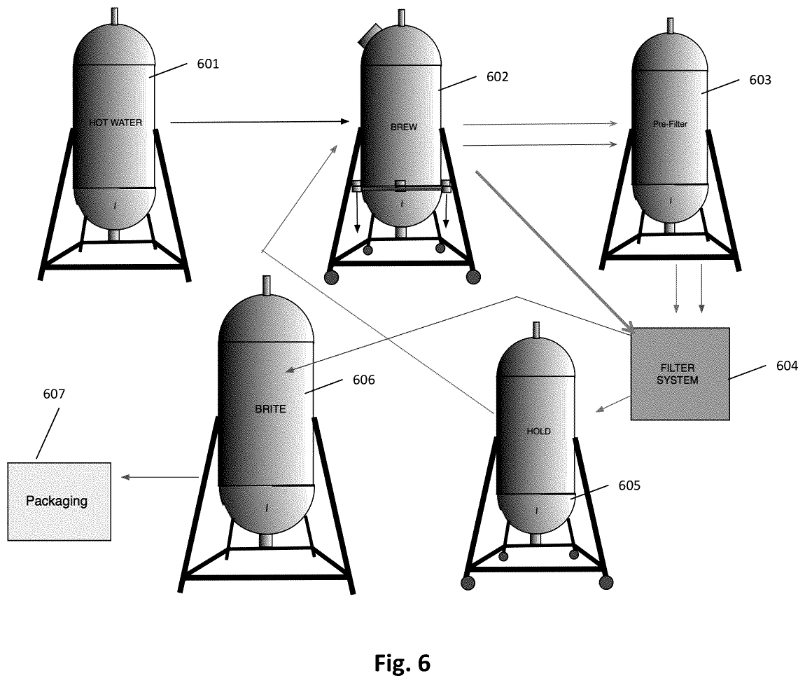

FIG. 6 shows a more complex recirculation loop from the brewing system of FIG. 3. Water or a solvent begins at a first water vessel 601, proceeds to a vacuum/brewing vessel 602, then to a pre-filter vessel 603 before moving to a filtration system 604. Alternatively, liquid may be pumped directly from the vacuum/brewing vessel 602 through the filtration system 604. The filtered liquid is then moved to a holding tank 605 before being cycled back into the vacuum/brewing vessel 602, which has been filled with additional coffee or brewing material. The liquid repeats these circulation steps as many times as necessary before moving to the brite tank 606 for packaging 607.

what is claimed is:

1. A vacuum-extraction method for producing a twice-brewed liquid, the method comprising:
first preparing a liquid water or solvent to a first brewing temperature;
combining the liquid water or solvent with a first brewing material in the brewing vessel above a filter;
removing air from the brewing vessel until a first low-pressure set point below ambient pressure is reached;
closing the brewing vessel from ambient air and first steeping the mixture of the liquid water or solvent and the first brewing material while maintaining the first low-pressure set point in the brewing vessel for a first low-pressure steeping time;
directing the liquid water or solvent and the first brewing material through the filter to yield a filtered brewed liquid while the first brewing material remains above the surface of the filter;
transferring at least a first portion of the filtered brewed liquid to a holding chamber and stabilizing a temperature of the at least first portion of the filtered brewed liquid in the holding chamber to a target temperature;
transferring at least a second portion of the first portion of the filtered brewed liquid back to the brewing vessel; and
second steeping the second portion of filtered brewed liquid and a second brewing material in the brewing vessel to produce a twice-brewed liquid.

2. The method of claim 1 further comprising:
second preparing a liquid water or solvent to a second brewing temperature and adding the second prepared liquid water or solvent to the brewing vessel prior to the step of second steeping, so that the step of second steeping includes steeping a mixture of the second prepared liquid water or solvent, the second portion of the first portion of the filtered brewed liquid, and the first brewing material.
